(19) United States
(12) Patent Application Publication
(10) Pub. No.: US 2017/0285778 A1
(43) Pub. Date: Oct. 5, 2017

(54) ELECTRONIC DEVICE WITH FINGERPRINT SENSOR

(71) Applicant: Intel Corporation, Santa Clara, CA (US)

(72) Inventor: Chung-yu Liang, Zhubei City (TW)

(73) Assignee: Intel Corporation, Santa Clara, CA (US)

(21) Appl. No.: 15/088,411

(22) Filed: Apr. 1, 2016

(51) Int. Cl. G06F 3/041; G06K 9/00

(52) U.S. Cl. CPC G06F 3/041; G06K 9/00006

(57) ABSTRACT

An electronic device having a display panel, a touch panel, and a fingerprint sensor panel. The touch panel is disposed on the display panel. The fingerprint sensor panel is disposed on the touch panel. The touch panel has a touch sensor. The fingerprint sensor panel has a fingerprint sensor.

### TECHNICAL FIELD

The present techniques relate generally to electronic devices with a touch sensor, and more particularly, to electronic devices having a fingerprint sensor at least partially overlaying the touch sensor.

### BACKGROUND ART

A touchscreen is an input device normally layered on the top of an electronic visual display of an information processing system. A user can interact with the information processing system by touching the screen. The user can use the touchscreen to react to what is displayed and to control how text or graphics are displayed; for example, zooming to increase the text size. The touchscreen may facilitate the user to interact directly with what is displayed. Touchscreens are common in devices such as game consoles, personal computers, tablet computers, electronic voting machines, smartphones, and digital appliances. Touchscreens can be attached to computers or, as terminals, to networks. Further, touchscreens are found in the medical field and in heavy industry, as well as for automated teller machines (ATMs), and kiosks such as museum displays or room automation. The popularity of smartphones, tablets, and many types of information appliances is driving the demand and acceptance of common touchscreens for portable and functional electronics. Display manufacturers and chip manufacturers have acknowledged the trend toward acceptance of touchscreens as a desirable user interface component and have begun to integrate touchscreens into the design of their products.

Fingerprint recognition or fingerprint authentication refers to a technique of verifying a match between two human fingerprints. Fingerprints are one of several forms of biometrics used to identify individuals and verify their identity. The analysis of fingerprints for matching purposes generally utilizes the comparison of several features of the print pattern. These may include patterns, which are aggregate characteristics of ridges, and minutia points, which are unique features found within the patterns. A fingerprint sensor may be an electronic component used to capture a digital image of the fingerprint pattern. The digital image may be digitally processed to create a biometric template (a collection of extracted features) which is stored and used for matching. Matching procedures and rules may be employed to compare previously stored templates of fingerprints against candidate fingerprints for authentication purposes. The original image may be directly compared with the candidate image, and/or certain features may be compared. Pattern-based comparisons may evaluate basic fingerprint patterns (arch, whorl, and loop) between a previously stored template and a candidate fingerprint. In a pattern-based comparison, the template may have the type, size, and orientation of patterns within the aligned fingerprint image. The candidate fingerprint image may be graphically compared with the template to determine the degree to which they match. Technologies used to capture a fingerprint include optical, capacitive, thermal, piezoresistive, ultrasonic, piezoelectric, microelectromechanical systems (MEMS), and radio frequency (RF). Optical fingerprint imaging may involve capturing a digital image of the print using visible light. Ultrasonic sensors may use very high frequency sound waves to penetrate the epidermal layer of skin to create visual images of the fingerprint. The sound waves are typically generated using piezoelectric transducers and reflected energy measured using piezoelectric materials. Capacitance sensors employ principles associated with capacitance in order to form fingerprint images. In such a technique of imaging, the sensor array pixels may each act as one plate of a parallel-plate capacitor, the dermal layer (which is electrically conductive) acts as the other plate, and the non-conductive epidermal layer acts as a dielectric. Capacitance sensors may be passive sensors or active sensors. Some smartphones have a capacitance fingerprint sensor.

### BRIEF DESCRIPTION OF DRAWINGS

FIG. 1 is a diagram of first electronic device having a fingerprint sensor on a border. Also depicted is a second electronic device (on the right) having a fingerprint sensor panel on top of a touch panel in accordance with embodiments of the present techniques.

FIG. 2 is a cross-section representation of the electronic devices of FIG. 1. The second device on the right is in accordance with embodiments of the present techniques.

FIG. 2A is the same as FIG. 2 except that the second device does not have a cover in the touch panel, in accordance with embodiments of the present techniques.

FIG. 3 is a cross-section representation of a touch display of an electronic device having a localized fingerprint sensor above a touch panel in accordance with embodiments of the present techniques.

FIG. 3A is the same as FIG. 3 except that the device does not have a cover in the touch panel, in accordance with embodiments of the present techniques.

FIG. 4 is a diagrammatical representation an electronic device having a circuit board in accordance with embodiments of the present techniques.

FIG. 4A is the same as FIG. 4 except that the device does not have a cover in the touch panel, in accordance with embodiments of the present techniques.

FIG. 5 is a cross-section representation of an electronic device having a fingerprint sensor above a touch panel in accordance with embodiments of the present techniques.

FIG. 6 is a block diagram of a method of manufacturing an electronic device in accordance with embodiments of the present techniques.

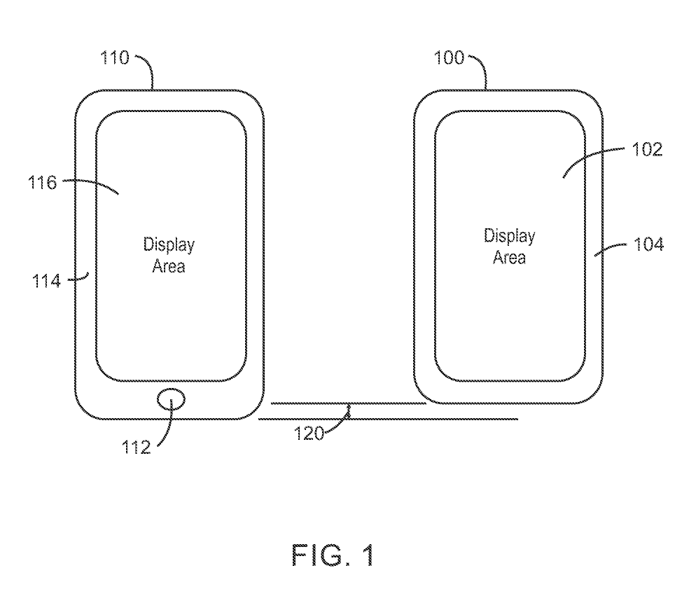

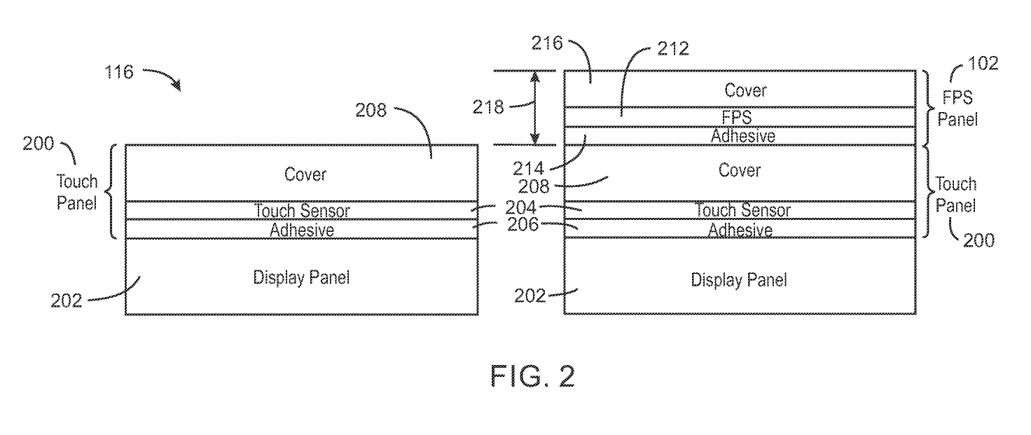

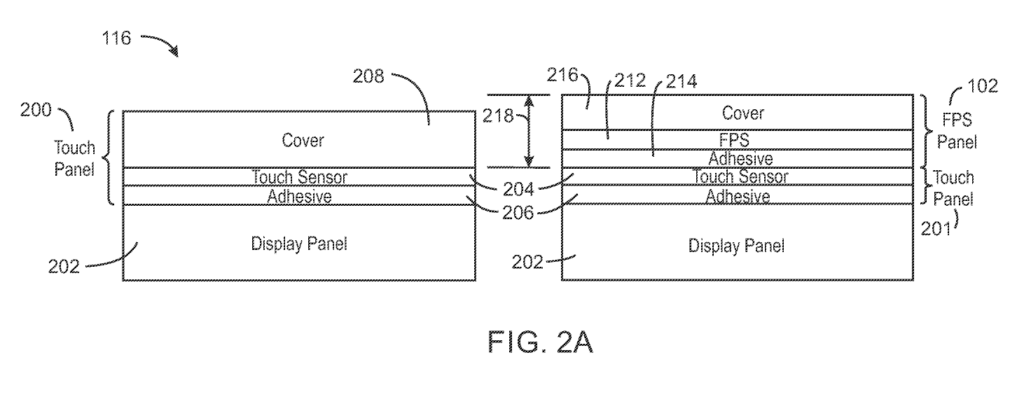

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION

The present techniques relate generally to an electronic device (e.g., smartphone, tablet, computer monitor, etc.) having a display panel, a touch panel (with touch sensor) disposed on the display panel, and a fingerprint sensor panel (with fingerprint sensor) disposed on the touch panel. The fingerprint sensor panel may be disposed over most or all of the touch panel, or on a portion of the touch panel. Being so disposed, the fingerprint sensor panel may be a different layer than the touch panel and not integrated physically through the touch panel. The fingerprint sensor panel may be transparent or substantially transparent such that a user can view the display clearly. Furthermore, with different frequency between touch and finger print controllers, operation of the touch panel through the fingerprint sensor panel can avoid operation of the fingerprint sensor panel. Yet, the fingerprint sensor panel and touch panel, while not physically interleaved or significantly interleaved, may have integration at a software level. As for hardware, in certain embodiments, the touch sensor and the fingerprint sensor may share the same circuit board. Indeed, in some examples, the circuit board may have both a touch-panel integrated circuit (IC) coupled to the touch sensor, and a fingerprint-sensor IC coupled to the fingerprint sensor.

As discussed below, the fingerprint sensor (FPS) panel on the display area may reduce the size of the electronic device, as compared to an electronic device having a fingerprint sensor disposed outside the display area. Further, embodiments may provide for increased display area. In addition, the techniques may give increased area to read the fingerprint facilitating accuracy of the fingerprint scan and reading. Moreover, as mentioned for some embodiments, the system may be integrated at the software level in that the touch sensor of the touch panel and the FPS of the FPS panel can work together. In other words, disposing the FPS panel physically on top of the touch panel may involve software integration between operation of the FPS and operation of the touch sensor.

FIG. 1 depicts to the right in the diagram of FIG. 1, an electronic device 100 (e.g., mobile device, tablet, smartphone, etc.) having a fingerprint panel 102 on a touch display (underneath the fingerprint panel 102). The fingerprint panel 102 and underlying touch display are surrounded by a border 104 of the body of the electronic device 100. In some embodiments, the fingerprint panel 102 is a component of the underlying touch panel or touch sensor. Instead, the fingerprint panel 102, for example, sits atop (and coupled to) the touch panel. Moreover, the fingerprint panel 102 may be transparent or substantially transparent.

Also depicted is an electronic device 110 (to the left in FIG. 1) not having a fingerprint panel atop the touch display but instead having a fingerprint sensor 112 on the body border 114 surrounding the touch display 116. For the electronic device 110, the fingerprint sensor 112 may or may not be associated, for example, with a home button or similar implementation of the electronic device 110. The electronic devices 100 and 110 may be smartphones, tablets, laptops, all-in-one computers devices, televisions, computer monitors for a laptop, desktop, or for other computer arrangements, and so forth.

For the electronic device 110, the fingerprint sensor 112 is a discrete component on the electronic device 110 (e.g., mobile device) outside of the display area. Thus, in such an eco-system, the fingerprint sensor 112 will occupied an extra place or surface area on the face of the mobile device. For instance, the fingerprint sensor 112 may be placed at the bottom of the face outside of the touch display 116 of the mobile device, as depicted for the electronic device 110. In contrast, the technique for the electronic device 100 structure can release or result in extra space or surface to make the device 100 more compact or smaller but with the same display size (same surface area), as shown in the FIG. 1, or to have a larger display size.

In the illustrated example, the respective display areas of the electronic devices 100 and 110 are the same size but the surface area of the border 104 of the electronic device 100 is less than the surface area of the border 114 of the electronic device 110, as indicated by reference numeral 120. Of course, in other examples with the electronic device 100 having a fingerprint sensor (FPS) panel 102 atop or over the touch display (instead of having a discrete fingerprint sensor disposed on the border as with the electronic device 110), the display area of the electronic device 100 may be greater. In other words, the display area of the electronic device 100 may be greater than the display area of the electronic device 110 for the same area of the overall faces (display area plus border area) of the electronic devices 102 and 110, for instance. The electronic device 100 may have physical and/or virtual buttons or controls (not shown). Lastly, the FPS panel 102 of the electronic device 100 may be full screen or localized, as discussed below.

FIG. 2 is a cross-section representation of the electronic devices 100 and 110. For the electronic device 110, the touch display 116 has a touch panel 200 on top of (e.g., laminated on) a display panel 202. The touch panel 200 may have a touch sensor 204 and an adhesive 206 coupling the touch sensor 204 to the display panel 202. The touch panel 200 may have a glass cover 208.

As for the electronic device 100, the device 100 may include a touch panel 200 and a display panel 202. Further, the electronic device 100 may include a FPS panel 102 on top of the touch panel 200. Thus, the touch panel 200 and the FPS panel 102 may be laminated on the display panel 202. Therefore, the electronic device 100 may have at least three panels including the FPS panel 102, the touch panel 200, and the display 202. FIG. 2A is the same as FIG. 2, except that for the electronic device 100, the touch panel 201 does not have a cover 208.

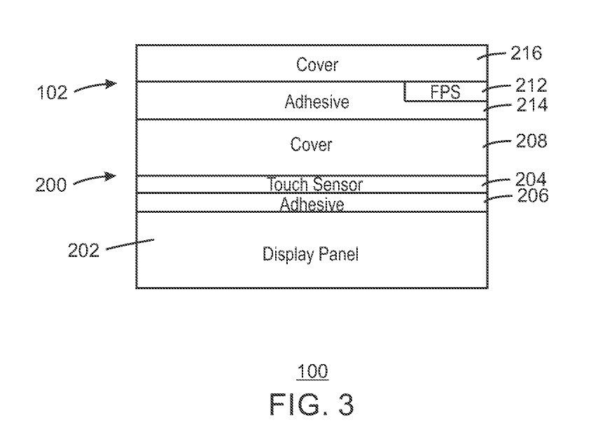

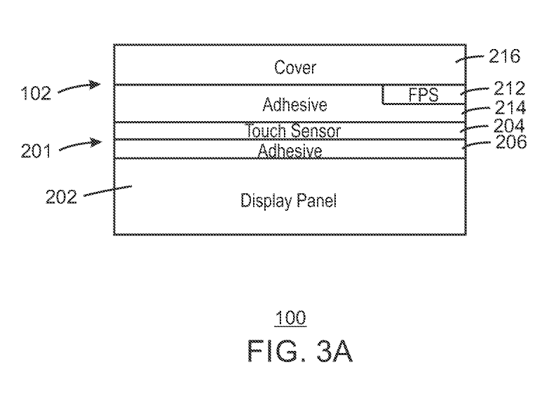

In the illustrated embodiments of FIGS. 2 and 2A, the FPS panel 102 includes a fingerprint sensor (FPS) 212 and an adhesive 214 coupling the FPS 212 to the touch panel 200 (or 201), e.g., coupling the FPS 212 to a top surface of the glass cover 208 (or of the touch sensor 204) of the touch panel 200. Therefore, the FPS 212 may be separate from the touch sensor 204. In examples, the FPS panel 102 (having FPS 212) is not interweaved through the touch panel 200 or 201 or touch sensor 204. For instance, the adhesive 214 in the same implementation may both couple the FPS 212 to the touch panel 200 or 201 and separate the FPS 212 from the touch panel 200 or 201. Moreover, the FPS 212 may be full frame (or substantially full frame), as depicted. On the other hand, the FPS 212 may be localized (see, e.g., FIG. 3).

Examples of the adhesive 214 include LOCA (Liquid Optically Clear Adhesive) film, or OCR (Optically Clear Resin), or other adhesives or resins. The FPS 212 may be indium tin oxide (ITO), carbon nanotubes, or other transparent conductive material, non-transparent material such fine line metal mesh, and so forth. Further, the FPS panel 102 may include a cover 216 such as a transparent cover. The cover 216 may be glass, inorganic glass, sapphire film, plastic, polymethylmethacrylate (PMMA), polycarbonate, or other transparent material.

In some embodiments, the FPS panel 102 is less than 0.5 millimeters (mm) in thickness (reference numeral 218), and the FPS panel cover 216 is less than 0.4 mm in thickness. However, a combined thickness of the FPS 212 plus the adhesive 214 may be in the range of 0.01 mm to 0.3 mm, 0.1 mm to 0.3 mm, 0.1 mm to 0.4 mm, and so on. Of course other thicknesses of the FPS panel 102 and its components are applicable. Moreover, in some embodiments, FPS panel 102 may include the FPS 212 and the cover 216, and with the adhesive 214 considered a component separate from the FPS panel 102.

Compared to a discrete FPS, the FPS integrated on a display area may give increased display/device outline ratio to thus improve user experience. The size of the electronic device 100 (e.g., smartphone or tablet) can be reduced and/or fitted with a larger screen. Moreover, the present technique of disposing (laminating) a FPS panel 102 on a touch panel may be advantageous compared to integrating a FPS into the display panel or touch panel. Yet, such an integration of an FPS into the display panel or touch panel may be problematic because, for example, a gap smaller than 0.3 mm between the user's finger and the FPS may be beneficial. Moreover, a fine sensor pitch (e.g., 50 microns or μm) for a FPS can be generally readily employed in the FPS panel in embodiments of the present techniques, whereas conversely such a fine sensor pitch may be difficult in a touch panel or to integrate into a LCD panel, for instance.

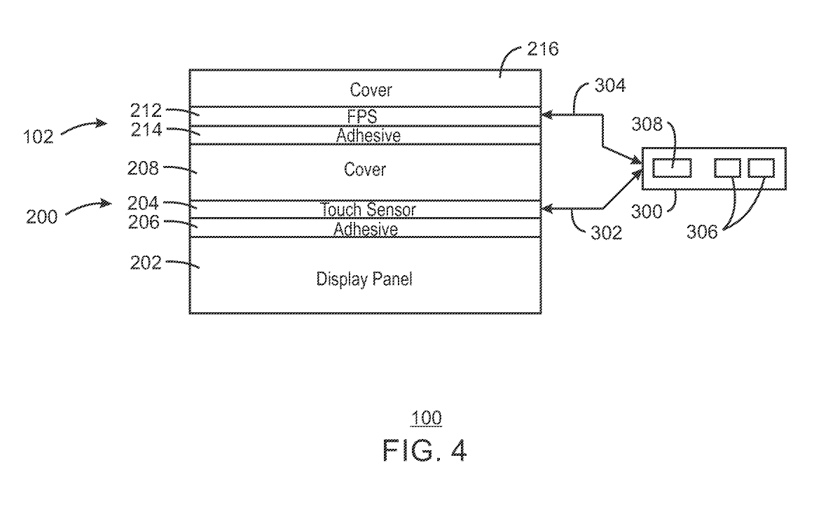

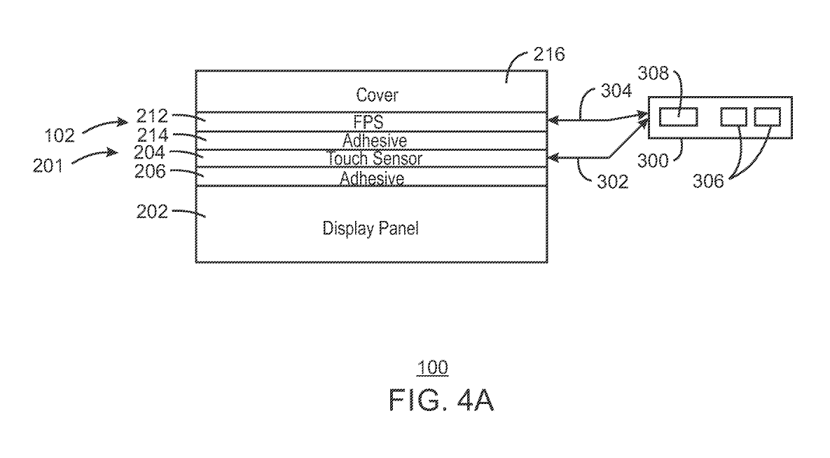

The FPS panel 102 may be an advantageous implementation to be added on a touch screen, or on a display of a product without a touch panel. In some embodiments, the FPS panel 102 or similar FPS panel 102 may be laminated on a traditional touch/display module. The FPS sensor may be a full screen or localized, depending on the application, for example. Both the touch panel and FPS panel can share the same control board to save cost, or instead have separate boards depending on business flexibility, for instance. FIG. 4 discuss below depicts the electronic device 100 having the three panels (adhesive between the panels) and with the example of sharing the same touch control board.

Technologies for a FPS to capture a fingerprint include optical, capacitive, thermal, piezoresistive, ultrasonic, piezoelectric, MEMS, RF, and the like. A FPS controller or integrated circuit, and associated software and/or firmware, may facilitate the FPS to capture the image or fingerprint, provide for image processing and categorization, perform the matching calculations, and so on. As mentioned, a FPS IC may share a circuit board with the touch-sensor IC, or the FPS IC may be dispose on a circuit board different then the circuit board for the touch-sensor IC.

A touch-controller associated with a touch sensor may generally be a small microcontroller-based chip that sits between the touch sensor and the embedded system controller, for example. This chip can either be located on a controller board inside the system or it can be located on a flexible printed circuit (FPC) affixed to the glass touch sensor. A touch-controller or touch-sensory integrated circuit (IC) may translate information from the touch sensor for the electronic device or embedded system controller. In general, a touch panel or touch sensor may be a clear glass panel with a touch responsive surface. This touch sensor may be placed over a display panel (e.g., a liquid crystal display or LCD) so that the touch area of the panel covers the viewable area of the video screen. Touch-sensor technologies to detect touch input may use an electrical current running through the touch sensor panel that, when the touch sensor panel is touched, causes a voltage or signal change. This voltage may be sensed by the touch controller to determine the location of the touch on the screen. Touchscreen driver software can be either shipped from the factory (within the embedded OS of a cell phone) or offered as add-on software (such as with adding a touchscreen to a traditional personal computer or PC). This software may facilitate the touchscreen and system controller to work together and facilitates the product's operating system to interpret the touch event information sent from the controller.

FIG. 3 is a cross-section representation of a touch display of an example the electronic device 100 having a localized FPS 212. Included is a display panel 202, a touch panel 200, and a FPS panel 102. The touch panel 200 includes a glass cover 208, a touch sensor 204, and an adhesive 206 coupling the touch sensor 204 to the underlying display panel 202. FIG. 3A is the same as FIG. 3 except that the touch panel 201 does not include a cover 208.

The FPS panel 102 includes a cover 216 (e.g., transparent or substantially transparent), a FPS 212, and an adhesive 214 coupling the FPS 212 to the glass cover 208 (or touch sensor 204) of the touch panel 200 (or 201). The FPS 212 is not full frame but instead is localized, e.g., 2 centimeters (cm) by 2 cm.

FIG. 4 is a diagrammatical representation of an example of the electronic device 100 including the touch display coupled to a circuit board 300. Included are the display panel 202, touch panel 200, and FPS panel 102 depicted previously. Additionally, a circuit board 300 is coupled to the touch sensor 204 and FPS 212, as indicated by reference numerals 302 and 304, respectively. In particular, the circuit board 300 may have a touch-sensor integrated circuit(s) 306 coupled to the touch sensor 204, and a fingerprint-sensor integrated circuit 308 coupled to the FPS 212. It should be noted, the touch-sensor integrated circuit(s) 306 and the finger-print sensor integrated circuit 308 may instead be on separate circuit boards. In operation, the FPS 212 may be used to read a fingerprint to unlock a screen, for example, or to read a fingerprint for a business transaction, and so forth. FIG. 4A is the same as FIG. 4 except that the touch panel 201 does not have a cover 208.

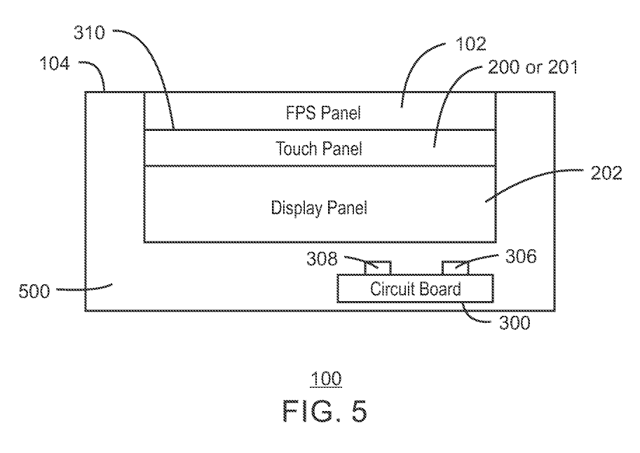

FIG. 5 is a cross-section representation of the electronic device 100 having a body 500 holding a FPS panel 102, a touch panel 200 or 201, and a display panel 202. As discussed, the FPS panel 102 may be disposed on top surface 310 of the touch panel 200 or 201. Therefore, a FPS need not be disposed on a border 104 of the electronic device 100. The electronic device 100 may include one or more circuit boards 300. A circuit board 300 may have a touch-sensor integrated circuit (IC) 306 and/or a FPS IC 308. The electronic device 100 may be a smartphone, tablet, laptop, all-in-one (AIO) computer, computer monitor, television system, medical device, process control computer, and so forth.

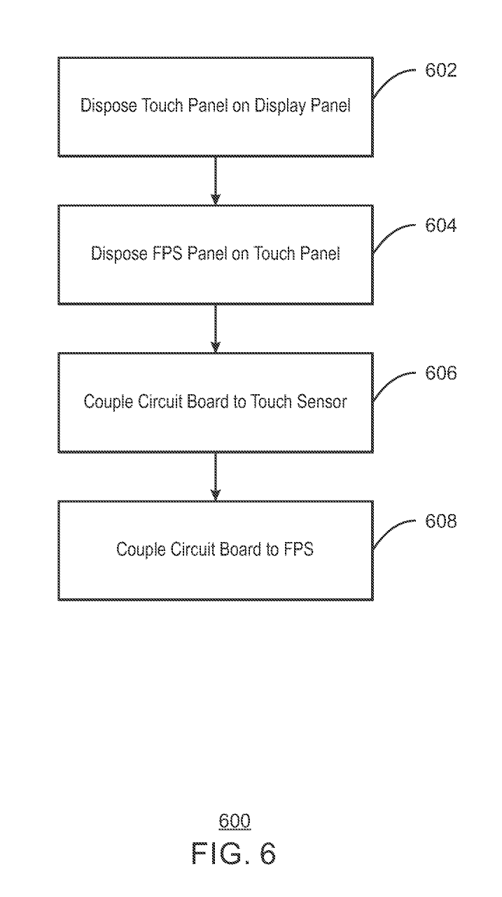

FIG. 6 is a method 600 of manufacturing an electronic device. The electronic device may be a smartphone, tablet, laptop, AIO computer, computer monitor, television system, medical device, process control computer, and so forth. In the illustrated embodiment, the method includes disposing (block 602) a touch panel on a display panel. The touch panel may have a touch sensor and an adhesive coupling the touch sensor to the display panel. Further, the touch panel may have a cover such as a glass cover. In other examples, the touch panel does not have a cover. At block 604, the method includes disposing a fingerprint sensor panel on the touch panel, such as on the glass cover or touch sensor of the touch panel. The fingerprint sensor panel may have a fingerprint sensor and an adhesive coupling the fingerprint sensor to the touch panel. Further, the fingerprint panel may include a cover that is transparent or substantially transparent.

Moreover, the fingerprint sensor may be full frame or substantially full frame. Indeed, the action of disposing the fingerprint sensor panel on the touch panel may be disposing the fingerprint sensor over at least a majority of a top surface of the touch panel. On the other hand, the fingerprint sensor may be localized, covering less than a majority of the of a top surface of the touch panel (e.g., covering less than a majority of a top surface of a glass cover and/or touch sensor of the touch panel).

At block 606, the method 600 includes coupling a circuit board to the fingerprint sensor, wherein the circuit board has a finger-sensor integrated circuit. At block 608, the method includes coupling a circuit board to the touch sensor, wherein the circuit board has a touch-sensor integrated circuit. In certain embodiments, the circuit board in the actions represented by blocks 606 and 608 is the same circuit board.

Lastly, a method of operating an electronic device having a FPS panel 102 may include receiving a finger placed on a display area of the electronic device, wherein the display area includes a touch panel disposed below the FPS panel, the fingerprint sensor panel having a fingerprint sensor disposed over a touch sensor of the touch panel. The method may read, via the fingerprint sensor, a fingerprint of the finger in response to a user requesting the electronic device to read the fingerprint. The method may include detecting, via the touch sensor, a desired action of the electronic device by the user based on coordinates of finger.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment”, “one embodiment”, “some embodiments”, “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

Examples are given. Example 1 is an electronic device. The electronic device includes a display panel; a touch panel disposed on the display panel, the touch panel comprising a touch sensor; and a fingerprint sensor panel disposed on the touch panel, the fingerprint sensor panel comprising a fingerprint sensor.

Example 2 includes the electronic device of example 1, including or excluding optional features. In this example, the touch panel comprises an adhesive coupling the touch sensor to the display panel.

Example 3 includes the electronic device of any one of examples 1 to 2, including or excluding optional features. In this example, the fingerprint sensor panel comprises a cover, the fingerprint sensor, and an adhesive coupling the fingerprint sensor to the touch panel.

Example 4 includes the electronic device of any one of examples 1 to 3, including or excluding optional features. In this example, the fingerprint sensor is disposed over at least a majority of a top surface of the touch panel.

Example 5 includes the electronic device of any one of examples 1 to 4, including or excluding optional features. In this example, the electronic device is a smartphone, a tablet, a laptop computer, or an all-in-one computer.

Example 6 includes the electronic device of any one of examples 1 to 5, including or excluding optional features. In this example, the electronic device includes a body holding the display panel, the touch panel, and the fingerprint sensor panel.

Example 7 includes the electronic device of any one of examples 1 to 6, including or excluding optional features. In this example, the electronic device includes a circuit board comprising a fingerprint-sensor integrated circuit coupled to the fingerprint sensor. Optionally, the circuit board comprises a touch-panel integrated circuit coupled to the touch sensor.

Example 8 is a method of manufacturing an electronic device. The method includes disposing a touch panel on a display panel, the touch panel comprising a touch sensor and a first adhesive coupling the touch sensor to the display panel; and disposing a fingerprint sensor panel on the touch panel, the fingerprint sensor panel comprising a fingerprint sensor and a second adhesive coupling the fingerprint sensor to the touch panel.

Example 9 includes the method of example 8, including or excluding optional features. In this example, the touch panel comprises a glass cover.

Example 10 includes the method of any one of examples 8 to 9, including or excluding optional features. In this example, the fingerprint sensor panel comprises a transparent cover.

Example 11 includes the method of any one of examples 8 to 10, including or excluding optional features. In this example, disposing a fingerprint sensor panel on the touch panel comprises disposing the fingerprint sensor over at least a majority of a top surface of the touch panel.

Example 12 includes the method of any one of examples 8 to 11, including or excluding optional features. In this example, the electronic device is a smartphone.

Example 13 includes the method of any one of examples 8 to 12, including or excluding optional features. In this example, the method includes coupling a circuit board to the fingerprint sensor, wherein the circuit board comprises a fingerprint-sensor integrated circuit. Optionally, the method includes coupling the circuit board to the touch sensor, wherein the circuit board comprises a touch-sensor integrated circuit.

Example 14 is an electronic device. The electronic device includes a touch display comprising: a display panel; and a touch panel disposed on the display panel, wherein the touch panel comprises a touch sensor and a first adhesive coupling the touch sensor to the display panel; and a fingerprint sensor panel disposed on the touch panel, the fingerprint sensor panel comprising a fingerprint sensor and a second adhesive coupling the fingerprint sensor to the touch panel.

Example 15 includes the electronic device of example 14, including or excluding optional features. In this example, the touch panel comprises a glass cover.

Example 16 includes the electronic device of any one of examples 14 to 15, including or excluding optional features. In this example, the fingerprint sensor panel comprises a transparent cover.

Example 17 includes the electronic device of any one of examples 14 to 16, including or excluding optional features. In this example, the fingerprint sensor covers at least a majority of a top surface of the touch panel.

Example 18 includes the electronic device of any one of examples 14 to 17, including or excluding optional features. In this example, the electronic device includes a circuit board comprising a finger-sensor integrated circuit coupled to the fingerprint sensor. Optionally, the circuit board comprises a touch-panel integrated circuit coupled to the touch sensor.

Example 19 is an electronic device. The electronic device includes a display panel; a touch panel disposed on the display panel, the touch panel comprising a touch sensor; and a fingerprint sensor panel disposed on the touch panel, the fingerprint sensor panel comprising a fingerprint sensor and a cover.

Example 20 includes the electronic device of example 19, including or excluding optional features. In this example, the touch panel comprises a glass cover, the touch sensor, and an adhesive coupling the touch sensor to the display panel.

Example 21 includes the electronic device of any one of examples 19 to 20, including or excluding optional features. In this example, the fingerprint sensor panel comprises an adhesive coupling the fingerprint sensor to a glass cover of the touch panel.

Example 22 includes the electronic device of any one of examples 19 to 21, including or excluding optional features. In this example, the fingerprint sensor panel comprises an adhesive coupling the fingerprint sensor to the touch sensor of the touch panel.

Example 23 includes the electronic device of any one of examples 19 to 22, including or excluding optional features. In this example, the fingerprint sensor is disposed over at least a majority of a top surface of the touch panel.

Example 24 includes the electronic device of any one of examples 19 to 23, including or excluding optional features. In this example, the electronic device is a smartphone.

Example 25 includes the electronic device of any one of examples 19 to 24, including or excluding optional features. In this example, the electronic device is a tablet.

Example 26 includes the electronic device of any one of examples 19 to 25, including or excluding optional features. In this example, the electronic device includes a body holding the display panel, the touch panel, and the fingerprint sensor panel.

Example 27 includes the electronic device of any one of examples 19 to 26, including or excluding optional features. In this example, the electronic device includes a circuit board comprising a fingerprint-sensor integrated circuit coupled to the fingerprint sensor. Optionally, the circuit board comprises a touch-panel integrated circuit coupled to the touch sensor.

Example 28 is an electronic device. The electronic device includes means for displaying; means for sensing touch disposed on the means for displaying; and means for sensing a fingerprint disposed on the means for sensing touch.

Example 29 includes the electronic device of example 28, including or excluding optional features. In this example, the means for sensing touch is coupled to the means for displaying.

Example 30 includes the electronic device of any one of examples 28 to 29, including or excluding optional features. In this example, the means for sensing a fingerprint is coupled to the means for sensing touch.

Example 31 includes the electronic device of any one of examples 28 to 30, including or excluding optional features. In this example, the means for sensing a fingerprint is disposed over at least a majority of a top surface of means for sensing touch.

Example 32 includes the electronic device of any one of examples 28 to 31, including or excluding optional features. In this example, the electronic device is a smartphone.

Example 33 includes the electronic device of any one of examples 28 to 32, including or excluding optional features. In this example, the electronic device is a tablet.

Example 34 includes the electronic device of any one of examples 28 to 33, including or excluding optional features. In this example, the electronic device includes means for controlling the means for sensing a fingerprint. Optionally, the electronic device includes means for controlling the means for sensing touch.

Example 35 is a method of operating an electronic device. The method includes receiving, via a fingerprint sensor panel, a finger placed on a display area of the electronic device, the fingerprint sensor panel disposed on a touch panel of a display of the electronic device and comprising a fingerprint sensor; and reading, via the fingerprint sensor, a fingerprint of the finger.

Example 36 includes the method of example 35, including or excluding optional features. In this example, reading the fingerprint comprise reading, via the fingerprint sensor, the fingerprint of the finger in response to a user requesting the electronic device to read the fingerprint.

Example 37 includes the method of any one of examples 35 to 36, including or excluding optional features. In this example, the touch panel is disposed on a display panel and comprises a touch sensor.

Example 38 includes the method of any one of examples 35 to 37, including or excluding optional features. In this example, the method includes detecting, via the touch sensor, an action of the electronic device desired by the user based on or in response to positional coordinates of the finger on the touch sensor.

Example 39 is a method of fabricating an electronic device. The method includes disposing a touch panel on a display panel of the electronic device, the touch panel comprising a touch sensor and a first adhesive coupling the touch sensor to the display panel; disposing a fingerprint sensor panel on the touch panel, the fingerprint sensor panel comprising a fingerprint sensor and a second adhesive coupling the fingerprint sensor to the touch panel; and installing a circuit board in the electronic device, the circuit board comprising a touch-sensor integrated circuit.

Example 40 includes the method of example 39, including or excluding optional features. In this example, the touch panel does not comprise a cover.

Example 41 includes the method of any one of examples 39 to 40, including or excluding optional features. In this example, the fingerprint sensor panel comprises a cover.

Example 42 includes the method of any one of examples 39 to 41, including or excluding optional features. In this example, disposing a fingerprint sensor panel on the touch panel comprises disposing the fingerprint sensor over at least a majority of a top surface of the touch sensor.

Example 43 includes the method of any one of examples 39 to 42, including or excluding optional features. In this example, the electronic device is a mobile device.

Example 44 includes the method of any one of examples 39 to 43, including or excluding optional features. In this example, the electronic device is a smartphone or a tablet. Optionally, the method includes coupling the circuit board to the touch sensor. Optionally, the method includes coupling the circuit board to the fingerprint sensor, wherein the circuit board comprises a fingerprint-sensor integrated circuit.

Example 45 is an electronic device. The electronic device includes a display panel; a touch panel disposed on the display panel, the touch panel comprising a touch sensor; and a fingerprint sensor panel disposed on the touch panel, wherein the fingerprint sensor panel comprises a cover, a fingerprint sensor, and an adhesive coupling the fingerprint sensor to the touch panel.

Example 46 includes the electronic device of example 45, including or excluding optional features. In this example, the touch panel comprises an adhesive coupling the touch sensor to the display panel.

Example 47 includes the electronic device of any one of examples 45 to 46, including or excluding optional features. In this example, the fingerprint sensor is disposed over at least a majority of a top surface of the touch panel.

Example 48 includes the electronic device of any one of examples 45 to 47, including or excluding optional features. In this example, the electronic device is a smartphone, a tablet, a laptop computer, or an all-in-one computer.

Example 49 includes the electronic device of any one of examples 45 to 48, including or excluding optional features. In this example, the electronic device includes a circuit board comprising a fingerprint-sensor integrated circuit coupled to the fingerprint sensor.

Example 50 includes the electronic device of any one of examples 45 to 49, including or excluding optional features. In this example, the circuit board comprises a touch-panel integrated circuit coupled to the touch sensor.

Example 51 is a method of manufacturing an electronic device. The method includes disposing a touch panel on a display panel, the touch panel comprising a touch sensor and a first adhesive coupling the touch sensor to the display panel; and disposing a fingerprint sensor panel on the touch panel, the fingerprint sensor panel comprising a cover, a fingerprint sensor, and a second adhesive coupling the fingerprint sensor to the touch panel.

Example 52 includes the method of example 51, including or excluding optional features. In this example, the cover comprises a transparent cover.

Example 53 includes the method of any one of examples 51 to 52, including or excluding optional features. In this example, disposing the fingerprint sensor panel on the touch panel comprises disposing the fingerprint sensor over at least a majority of a top surface of the touch panel.

Example 54 includes the method of any one of examples 51 to 53, including or excluding optional features. In this example, the method includes coupling a circuit board to the fingerprint sensor, wherein the circuit board comprises a fingerprint-sensor integrated circuit. Optionally, the method includes coupling the circuit board to the touch sensor, wherein the circuit board comprises a touch-sensor integrated circuit.

Example 55 is an electronic device. The electronic device includes a touch display comprising: a display panel; and a touch panel disposed on the display panel, wherein the touch panel comprises a touch sensor and a first adhesive coupling the touch sensor to the display panel; and a fingerprint sensor panel disposed on the touch panel, the fingerprint sensor panel comprising a transparent cover, a fingerprint sensor, and a second adhesive coupling the fingerprint sensor to the touch panel.

Example 56 includes the electronic device of example 55, including or excluding optional features. In this example, the fingerprint sensor covers at least a majority of a top surface of the touch panel.

Example 57 includes the electronic device of any one of examples 55 to 56, including or excluding optional features. In this example, the electronic device includes a circuit board comprising a finger-sensor integrated circuit coupled to the fingerprint sensor.

Example 58 includes the electronic device of any one of examples 55 to 57, including or excluding optional features. In this example, the circuit board comprises a touch-panel integrated circuit coupled to the touch sensor.

It is to be understood that specifics in the aforementioned examples may be used anywhere in one or more embodiments. For instance, all optional features of the computing device described above may also be implemented with respect to either of the methods described herein or a computer-readable medium.

Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1. An electronic device comprising:
a display panel;
a touch panel disposed on the display panel, the touch panel comprising a touch sensor; and
a fingerprint sensor panel disposed on the touch panel, the fingerprint sensor panel comprising a fingerprint sensor and an adhesive adhering the fingerprint sensor panel to the touch panel.

2. The electronic device of claim 1, wherein the touch panel does not comprise a cover, wherein the adhesive directly adheres the fingerprint sensor to the touch sensor, and wherein the touch panel comprises an another adhesive directly adhering the touch sensor to the display panel.

3. The electronic device of claim 1, wherein the fingerprint sensor panel comprises a cover, wherein the cover is less than 0.4 millimeters (mm) in thickness, wherein the touch panel comprises a glass cover, and wherein the adhesive directly adheres the fingerprint sensor to the touch panel comprising directly adhering a bottom surface of the fingerprint sensor to a top surface of the glass cover.

4. The electronic device of claim 1, wherein the fingerprint sensor is disposed over at least a majority of a top surface of the touch panel, wherein the adhesive directly adheres the fingerprint sensor to the touch panel.

5. The electronic device of claim 1, wherein the electronic device is a smartphone, a tablet, a laptop computer, or an all-in-one computer, wherein the fingerprint sensor comprises a localized fingerprint sensor disposed over less than a majority of the touch panel, and wherein the adhesive directly adheres a bottom surface of the fingerprint sensor to the touch panel.

6. The electronic device of claim 1, comprising a body holding the display panel, the touch panel, and the fingerprint sensor panel, wherein the fingerprint sensor comprises a localized fingerprint sensor less than 2 centimeters (cm) in width and less than 2 cm in length.

7. The electronic device of claim 1, comprising a circuit board comprising a fingerprint-sensor integrated circuit coupled to the fingerprint sensor, wherein the fingerprint sensor panel is less than 0.5 mm in thickness, and wherein combined thickness of the fingerprint sensor and the adhesive is less than 0.4 mm.

8. The electronic device of claim 7, wherein the circuit board comprises a touch-panel integrated circuit coupled to the touch sensor, and wherein the fingerprint sensor comprises a fine sensor pitch less than 50 microns.

9. A method of manufacturing an electronic device, comprising:
disposing a touch panel on a display panel, the touch panel comprising a touch sensor and a first adhesive coupling the touch sensor to the display panel; and
disposing a fingerprint sensor panel on the touch panel, the fingerprint sensor panel comprising a fingerprint sensor and a second adhesive directly attaching a bottom surface of the fingerprint sensor to the touch panel.

10. The method of claim 9, wherein the touch panel comprises a glass cover, wherein the second adhesive directly attaches the bottom surface of the fingerprint sensor to a top surface of the glass cover.

11. The method of claim 9, wherein the fingerprint sensor panel comprises a transparent cover, wherein the transparent cover is less than 0.4 millimeters (mm) in thickness, wherein the fingerprint sensor panel is less than 0.5 mm in thickness, and wherein combined thickness of the fingerprint sensor and the second adhesive is less than 0.4 mm.

12. The method of claim 9, wherein disposing a fingerprint sensor panel on the touch panel comprises disposing the fingerprint sensor over at least a majority of a top surface of the touch panel, wherein the touch panel does not comprise a cover, wherein the second adhesive directly attaches the bottom surface of the fingerprint sensor to the touch sensor, and wherein the fingerprint sensor comprises a fine sensor pitch less than 50 microns.

13. The method of claim 9, wherein the electronic device is a smartphone not having a home button on a body front-surface border of the smartphone surrounding the touch panel, and not having a fingerprint sensor on the body front-surface border.

14. The method of claim 9, comprising coupling a circuit board to the fingerprint sensor, wherein the circuit board comprises a fingerprint-sensor integrated circuit, and wherein disposing the touch panel comprises the first adhesive directly attaching the touch sensor to the display panel.

15. The method of claim 14, comprising coupling the circuit board to the touch sensor, wherein the circuit board comprises a touch-sensor integrated circuit, and wherein the second adhesive separates the fingerprint sensor from the touch panel.

16. An electronic device comprising:
a touch display comprising:
a display panel; and
a touch panel disposed on the display panel, wherein the touch panel comprises a touch sensor and a first adhesive coupling the touch sensor to the display panel; and
a fingerprint sensor panel disposed on the touch panel, the fingerprint sensor panel comprising a fingerprint sensor and a second adhesive directly securing a bottom surface of the fingerprint sensor to the touch panel.

17. The electronic device of claim 16, wherein the touch panel comprises a glass cover, and wherein the second adhesive directly secures the bottom surface of the fingerprint sensor to a top surface of the glass cover.

18. The electronic device of claim 16, wherein the fingerprint sensor panel comprises a transparent cover, wherein the transparent cover is less than 0.4 millimeters (mm) in thickness, wherein the fingerprint sensor panel is less than 0.5 mm in thickness, and wherein combined thickness of the fingerprint sensor and the second adhesive is less than 0.4 mm.

19. The electronic device of claim 16, wherein the fingerprint sensor covers at least a majority of a top surface of the touch panel, wherein the first adhesive directly secures the touch sensor to the display panel, and wherein the fingerprint sensor comprises a fine sensor pitch less than 50 microns.

20. The electronic device of claim 16, comprising a circuit board comprising a finger-sensor integrated circuit coupled to the fingerprint sensor and a touch-panel integrated circuit coupled to the touch sensor, wherein the touch panel does not comprise a cover, and wherein the second adhesive directly secures the bottom surface of the fingerprint sensor to the touch sensor.

21. The electronic device of claim 16, wherein the fingerprint sensor comprises a localized fingerprint sensor covering less than a majority of the top surface of the touch panel, and wherein the localized fingerprint sensor is less than 2 centimeters (cm) in width and less than 2 cm in length.

22. An electronic device comprising:
a display panel;
a touch panel disposed on the display panel, the touch panel comprising a touch sensor and a first adhesive coupling the touch sensor to the display panel; and
a fingerprint sensor panel disposed on the touch panel, the fingerprint sensor panel comprising a fingerprint sensor, a cover, and a second adhesive directly coupling the fingerprint sensor to the touch panel, wherein the cover is less than 0.4 millimeters (mm) in thickness.

23. The electronic device of claim 22, wherein the touch panel comprises a glass cover, wherein the fingerprint sensor panel is less than 0.5 mm in thickness, and wherein combined thickness of the fingerprint sensor and the second adhesive is less than 0.4 mm.

24. The electronic device of claim 23, wherein the fingerprint sensor panel comprises the second adhesive directly coupling a bottom surface of the fingerprint sensor to a top surface of the glass cover of the touch panel, and wherein the fingerprint sensor comprises a localized fingerprint sensor covering less than a majority of the top surface of the touch panel.

25. The electronic device of claim 22, wherein the touch panel does not comprise a cover, wherein the fingerprint sensor panel comprises the second adhesive directly coupling a bottom surface of the fingerprint sensor to the touch sensor of the touch panel, and wherein the fingerprint sensor comprises a localized fingerprint sensor less than 2 centimeters (cm) in width and less than 2 cm in length.
